(19) United States
(12) Patent Application Publication
(10) Pub. No.: US 2003/0018897 A1
(43) Pub. Date: Jan. 23, 2003

(54) Video identification verification system and method for a self-checkout system

(75) Inventors: Donald Bellis JR., Canandaiga, NY (US); Paul Denimarck, Webster, NY (US); Barry Keys, Batavia, NY (US)

Correspondence Address: PSC SCANNING, INC. - STOEL RIVES LLP, C/O STOEL RIVES LLP, 900 SW 5TH AVENUE, PORTLAND, OR, 97204, US

(73) Assignee: PSC Scanning, Inc.

(21) Appl. No.: 09/909,481

(22) Filed: Jul. 20, 2001

(51) Int. Cl. H04L 9/32; H04K 1/00

(52) U.S. Cl. 713/182

(57) ABSTRACT

A system and method of verifying an identification of a customer using a self-checkout system of a retail establishment, the method including capturing an image of a customer's identification at the self-checkout system and displaying the customer's identification at a location remote from the self-checkout system to verify the identification of the customer. Capturing an image of a customer's identification may include, for example, obtaining an image of a customer's drivers license, retrieving stored information that would normally be found on a customer's drivers license such as a picture of the customer and personal information on the customer, and/or obtaining an image of the customer. This information may be displayed at an attendant station of the retail establishment so that an attendant can verify the customer's identity for purchasing age-restricted items such as tobacco products, alcoholic beverages, or certain solvents, or for other purposes.

### BACKGROUND OF THE INVENTION

The field of the present invention relates, in general, to self-checkout systems and methods, and, in particular, customer identification verification systems and methods for self-checkout systems.

In an effort to reduce a customer's waiting time in a checkout line of a retail establishment, manual price keying of each item being purchased has been replaced by the process of scanning a bar code of each item to obtain price information. Bar code readers are used in commercial and retail environments to accomplish this scanning process. In a retail checkout transaction, the consumer presents the items to be purchased to the cashier at a checkout register, and the cashier scans each item. In addition, there may be an ID check if the customer is purchasing an age-restricted item such as tobacco products, alcoholic beverages, or certain solvents. The transaction is completed once all the items have been scanned, all the coupons have been accepted, the total costs have been calculated, and the consumer has paid for the items. Even though scanning all the items at a checkout register takes less time than manually entering each item description into the computer, the sequential presentation to a cashier of each individual purchase can still take a long time and create long checkout lines. This time-consuming process can cause bottlenecks at the checkout stations, reducing throughput, making customers unhappy, and affecting the financial condition of a retail establishment.

A new way of conducting a checkout transaction is by self-checkout. In a self-checkout system, each customer, rather than the cashier, scans the bar codes of the items being purchased. After selecting all the shopping items, a customer brings all the items to a stationary self-checkout system. A self-checkout system typically comprises a scanner for reading the product and coupon bar codes, a weighing scale for weighing sale-by-weight items and item confirmation/security, and a checkout terminal for generating the final bill. Payment may be made, if the checkout system is so equipped, at the checkout system. Otherwise, payment is made at a central payment area.

Once at the self-checkout system, the customer scans the bar code of the item being purchased, and puts the item on the weighing scale so that it can be verified that the weight of the item on the scale matches stored weight information for the item scanned.

After all the purchases have been individually scanned and weight verified, any relevant coupons are also scanned. The customer requests the final bill by selecting an appropriate input on the checkout terminal. In response to the customer's request, the total purchase price is displayed on the terminal screen, and the bill is printed out. The customer tenders payment either at the checkout terminal or at the central payment area that is staffed by a store employee. The terminal can accept payments by any standard payment method. Once the bill has been paid and the receipt issued, the self-checkout transaction is finished, and the customer can leave the store.

In the event that the customer attempts to purchase a restricted item requiring verification of certain characteristics of the customer, a store employee such as a customer service manager or attendant is required to come over to the self-checkout system to verify the certain characteristics of the customer. For example, if the customer's items for purchase comprises age-restricted items such as tobacco products, alcoholic beverages, or certain solvents, the customer's age may have to be verified prior to the sale thereof. In particular, when the customer scans an age-restricted item into the self-checkout system, the customer service manager or attendant is notified via a sign such as a flashing light or an audible sound that intervention is needed prior to completing the customer's transaction, and the customer service manager must approach the customer and verify the customer's age by, for example, checking the customer's driver's license or other form of identification.

Such intervention has a number of drawbacks associated therewith. For example, the retailer must always have an employee such as the customer service manager or attendant readily available at or near the self-checkout system in order to verify the age of a customer upon entry of a restricted item. Such a requirement increases labor costs associated with the retailer's operation. Moreover, the requirement of such intervention may be inconvenient to the employee if the employee is constantly having to check the ages of the customers by walking over to the self-checkout systems, especially if the employee is expected to perform other employment duties. The requirement of such intervention may also be inconvenient to the retailer's customer. In particular, if a customer has completed checking out items for purchase, tendered payment therefor, and is ready to exit the store, the customer may be undesirably inconvenienced if the customer must wait for the customer service manager or attendant to approach the self-checkout system in order to verify the customer's age prior to exiting the store. Moreover, such a requirement reduces the throughput associated with the self-checkout system. In particular, if the customer is otherwise finished with operation of the self-checkout system, but must wait for the customer service manager or attendant to approach the self-checkout system to verify the customer's age, the customer is undesirably forced to remain at the system, thereby reducing the number of customers who may checkout their items for purchase via use of the system over a given period of time.

### SUMMARY OF THE INVENTION

The present invention in one aspect is directed to a method of verifying an identification of a customer using a self-checkout system of a retail establishment. The method comprises the steps of capturing an image of a customer's identification at the self-checkout system, and displaying the customer's identification at a location remote from the self-checkout system to verify the identification of the customer.

An additional aspect of the invention includes a video identification verification system for a self-checkout system of a retail establishment. In a preferred construction, the system includes a video source for use at the self-checkout system and adapted to capture an image of a customer's identification, and a video destination coupled to the video source and located at a location remote from the self-checkout system, the video destination adapted to display an image of the customer's identification to verify the identification of the customer.

Another aspect of the invention includes a method of verifying the identification of multiple customers of multiple respective self-checkout systems of a retail establishment. The method includes the steps of capturing images of the customers' respective identifications as respective video streams, combining the multiple video streams into a single stream with a multiplexer, separating the single stream into multiple video streams with a demultiplexer, and displaying multiple images of the customers' respective identifications resulting from the video streams at multiple destinations to verify the identifications of the customers.

Yet another aspect of the invention includes a video identification verification system for multiple respective self-checkout systems of a retail establishment. In a preferred construction, the system includes multiple video sources for use at the respective self-checkout systems, each video source being adapted to capture an image of a customer's identification at the self-checkout system and convert the image into a video stream, a multiplexer coupled to the video sources and adapted to combine the video streams from the video sources into one stream, a demultiplexer coupled to the multiplexer and adapted to separate the one stream into video streams, and multiple destinations located at locations remote from the self-checkout system, the multiple destinations coupled to the demultiplexer for receiving the video streams, each destination adapted to display an image of the customer's identification to verify the identification of the customer.

Other and further objects, features, aspects, and advantages of the present inventions will become better understood with the following detailed description of the accompanying drawings.

### BRIEF DESCRIPTION OF THE DRAWINGS

The following drawings illustrate both the design and utility of preferred embodiments of the invention. In the drawings, similar elements are referred to by common reference numbers.

FIG. 1 is perspective view of an embodiment of a self-checkout system.

FIG. 2 is a top plan view of multiple self-checkout systems in an exemplary retail environment.

FIG. 3 is a schematic illustration of an embodiment of a self-checkout computer of the self-checkout system illustrated in FIG. 1.

FIG. 4 is a block diagram of an embodiment of a video identification verification system.

FIG. 5A is an embodiment of a video source that may be used in the video identification verification system.

FIG. 5B is an alternative embodiment of a video source that may be used in the video identification verification system.

FIG. 5C is a further embodiment of a video source that may be used in the video identification verification system.

FIG. 6 is a block diagram of an alternative embodiment of a video identification verification system.

### DETAILED DESCRIPTION OF THE PREFERRED EMBODIMENTS

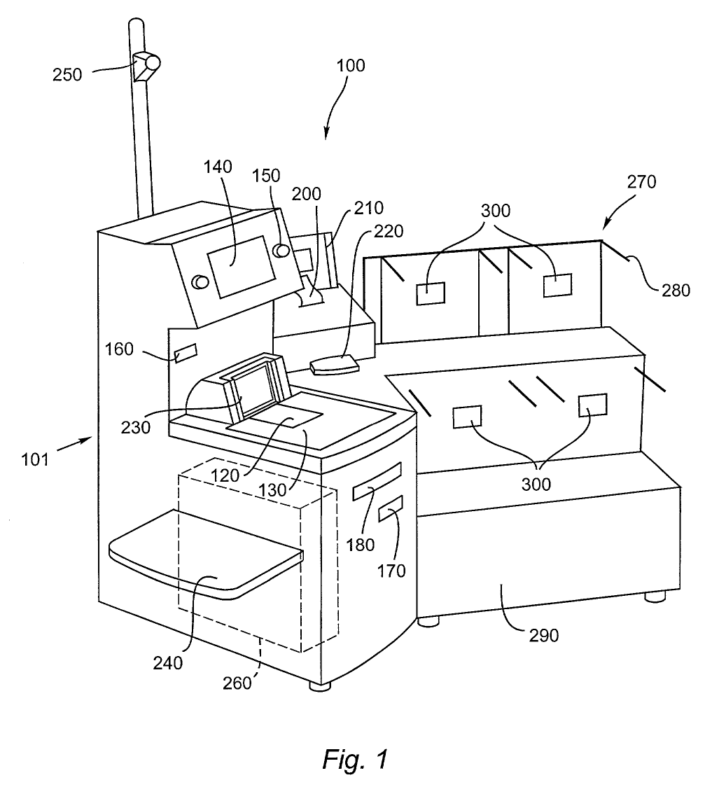

With reference to FIG. 1, a self-checkout system 100 constructed in accordance with preferred embodiment will now be described. The self-checkout system 100 will be described in conjunction with checking out or purchasing grocery store items in a grocery store or supermarket environment. However, the self-checkout system 100 may be used in retail or commercial establishments other than a grocery store such as, but not by way of limitation, convenience stores such as 7-Eleven™, drug stores such as Walgreen™ or super drug stores such as F & M™, and mass merchants such as WAL-MART™, TARGET™, etc. The self-checkout system 100 may be used in non-retail or non-commercial establishments such as, but not by way of limitation, a library.

With reference to FIG. 1, the self-checkout system 100 may include a system housing 110 that houses or carries an identification code reader 120 (e.g., bar code scanner), a weighing scale 130, a touch screen LCD display 140, speakers 150, a bill acceptor 160, a coin dispenser 170, a bill dispenser 180, a coupon reader 190, a receipt printer 200, an Electronic Funds Transfer (“EFT”)/magnetic strip card reader 210, a check reader/writer (MICR) 220, and a electronic article surveillance deactivator 230. A folding shelf 240 may be pivotally coupled to the housing 110 for temporary holding items to be purchased. A surveillance camera (e.g., CCD camera) 250 may be used capture images of self-checkout activity such as items to be purchased, and identification cards of customers. The system housing 110 preferably also houses a check-out terminal or computer 260 that, in order to control the system 100, may be coupled to the identification code reader 120, the weighing scale 130, the touch screen LCD display 140, the speakers 150, the bill acceptor 160, the coin dispenser 170, the bill dispenser 180, the coupon reader 190, the receipt printer 200, the Electronic Funds Transfer (“EFT”)/magnetic strip card reader 210, the check reader/writer (MICR) 220, the electronic article surveillance deactivator 230 and monitor(s), and the surveillance camera 250 in a well-known manner.

A bagging station 270 may be adjacent to, connected to, or integral with the system housing 100. The bagging station 270 may include multiple bag support arms 280 extending therefrom for holding shopping bags. The bagging station 270 may include one or more scales 290 coupled to the checkout terminal 260 for weighing checked-out items to verify they weigh the same as the items scanned into the system 100. The bagging station 270 may also include one or more electronic article surveillance monitors 300 coupled to the self-checkout computer 260 for verifying that all the items have been scanned into the system 100.

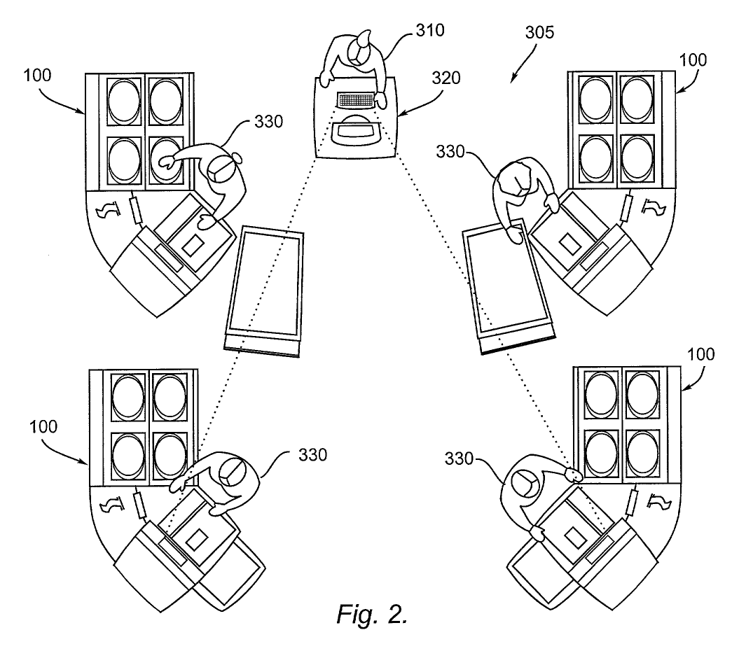

With reference to FIG. 2, the self-checkout system 100 may be one of many self-checkout systems 100 in a retail or commercial establishment 305 such as a grocery store. Preferably, an attendant or cashier 310 resides at an attendant station 320 positioned to strategically oversee customers 330 and self-checkout activity at the one or more self-checkout systems 100. The attendant station 320 may include an attendant computer system 322 including a monitor 324, and one or more input and output devices. In a preferred embodiment, one attendant 310 and attendant station 320 are provided for every four self-checkout systems 100. However, in alternative embodiments, the number of self-checkout systems 100, attendant stations 320, and/or ratio of self-checkout systems 100 to attendants 310/attendant stations 320 may vary.

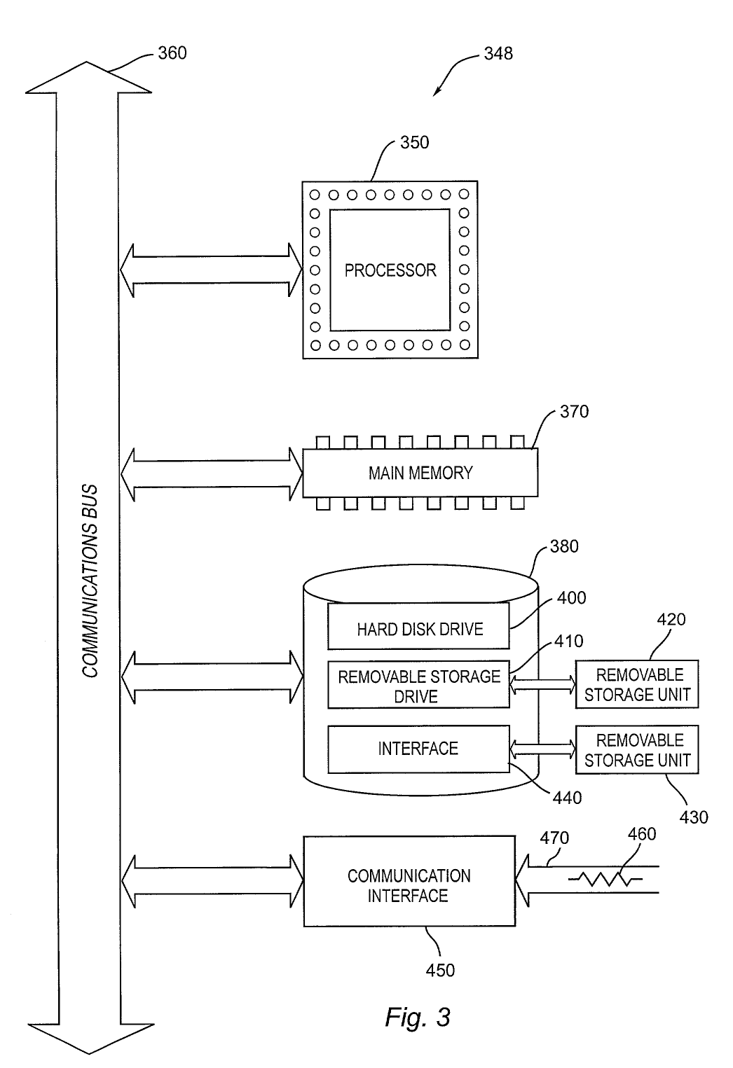

With reference to FIG. 3, an embodiment of an exemplary computer 348 that may be used as the self-checkout system computer 260, the customer service center computer 336, the attendant computer system 324, the central computer 840 or any other computer discussed herein will now be described. The system may also be implemented using other computer systems and/or computer architectures. The computer 348 may include hardware, software or a combination thereof and may be implemented in one or more computer systems or other processing systems.

The computer 348 may include one or more processors such as processor 350. The processor 350 is connected to a communication bus 360. The computer 348 also includes a main memory 370, preferably random access memory (RAM), and can also include a secondary memory 380.

The secondary memory 380 can include, for example, a hard disk drive 400 and/or a removable storage drive 410, representing a floppy disk drive, a magnetic tape drive, an optical disk drive, etc. The removable storage drive 410 reads from and/or writes to a removable storage unit 420 in a well-known manner. Removable storage unit 420, represents a floppy disk, magnetic tape, optical disk, etc. which is read by and written to by removable storage drive 410. As will be appreciated, the removable storage unit 420 includes a computer usable storage medium having stored therein computer software and/or data.

In alternative embodiments, secondary memory 380 may include other similar means for allowing computer programs, other instructions, or data to be loaded into the computer system 260. Such means can include, for example, a removable storage unit 430 and an interface 440. Examples of such can include a program cartridge and cartridge interface (such as that found in video game devices), a removable memory chip (such as an EPROM, or PROM) and associated socket, and other removable storage units 430 and interfaces 440 which allow software and data to be transferred from the removable storage unit 430 to computer system 348.

The computer 348 may also include a communications interface 450. The communications interface 450 allows software and data to be transferred between the computer 348 and external devices. Examples of communications interfaces 450 include, but not by way of limitation, a modem, a network interface (such as an Ethernet card), a communications port, a PCMCIA slot and card, etc. Software and data transferred via the communications interface 450 are in the form of signals 460 which can be electronic, electromagnetic, optical or other signals 460 capable of being received by communications interface 450. These signals 460 are provided to communications interface 450 via a channel 470. This channel 470 carries signals 460 and can be implemented using wire or cable, fiber optics, a phone line, a cellular phone link, an RF link and other communication channels 470.

In this document, the terms “computer program medium” and “computer usable medium” are used to generally refer to media such as removable storage unit 420, 430, a hard disk installed in hard disk drive 400, and signals 460. These computer program products are means for providing software and data to computer system 348.

Computer programs (also called computer control logic) may be stored in main memory 370 and/or secondary memory 380. Computer programs can also be received via communications interface 450. Such computer programs, when executed, enable the computer system 348 to perform the features of the system as discussed herein. In particular, the computer programs, when executed, enable the processor 350 to perform the features of the system. Accordingly, such computer programs represent controllers of the computer system 348.

In an embodiment where the system is implemented using software, the software may be stored in a computer program product and loaded into computer system 348 using removable storage drive 410, hard drive 400, or communications interface 450. The control logic (software), when executed by the processor 350, causes the processor 350 to perform the functions of the system as described herein.

In another embodiment, the system is implemented primarily in hardware using, for example, hardware components such as application specific integrated circuits (ASICs), a set of wired logic circuits, or an old-fashioned hardwired circuit of transistors, capacitors, and resistors.

In yet another embodiment, the system is implemented using a combination of both hardware and software.

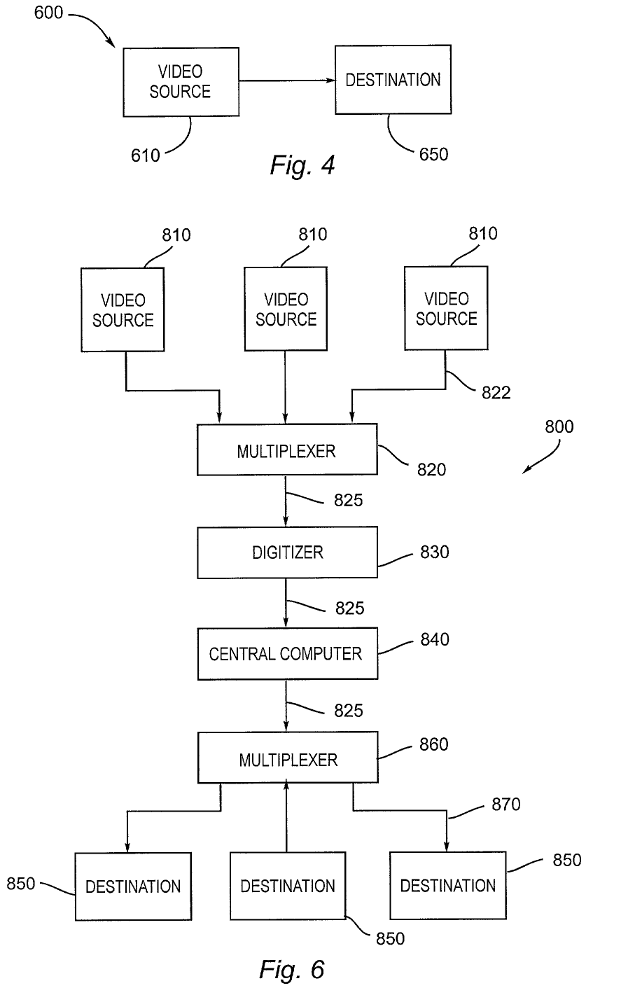

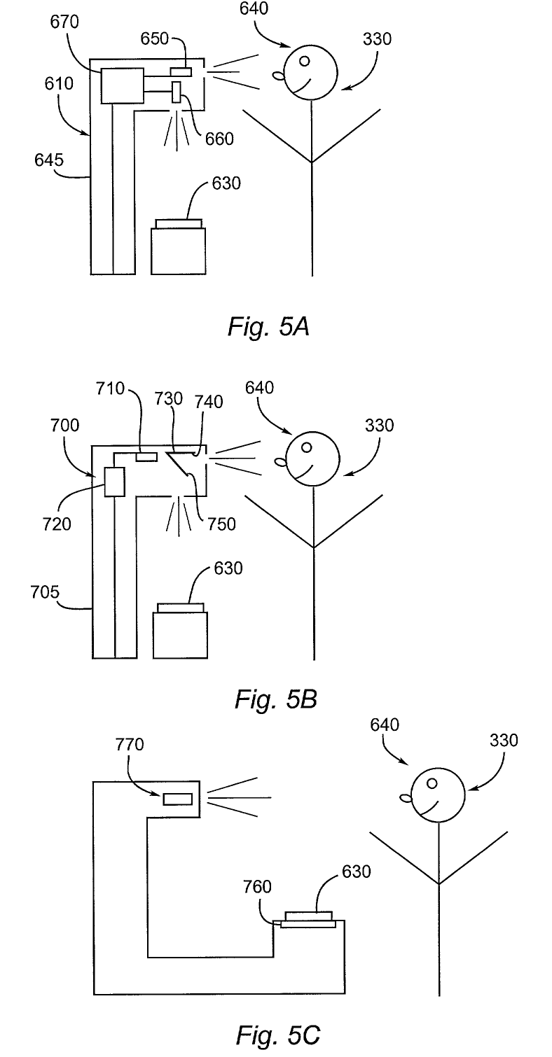

With reference to FIGS. 4 and 5A, an embodiment of a video verification system 600 for verifying one or more characteristics of a customer using a self-checkout system will now be described. The video verification system 600 generally includes a video source 610 coupled to a video destination 650. The video source 610 is adapted to obtain a real-time or live image of a customer's identification card 630 or may retrieve a stored image of the customer 330 and/or stored personal information such as that found on an identification card such as a drivers license. Alternatively or additionally, the video source 610 may be adapted to capture a real-time or live image of the facial appearance 640 of a customer 330. The video destination 650 may be adapted to display an image of the customer's identification card 630, a stored image of customer such as that normally found on an identification card, and/or a real-time captured facial appearance 640 of the customer 330.

The video source 610 is preferably a video camera (e.g., CCD camera) located at the self-checkout system 100. The video source 610 may include a camera housing 645 that carries a first camera head 650 and/or a second camera head 660 coupled to a camera control unit 670. The first camera head 650 may be used to capture a real-time image of the customer's facial appearance 640. The second camera head 660 may be used to capture an image of the customer's identification card 630. The camera heads may be adapted to capture a single image, multiple images, or running video. The camera control unit 670 processes and conditions the signal(s) received from the camera heads 650, 660. It should be noted, the camera may include variable optics/focus to obtain a clearer image of the customer's facial appearance 640 and/or identification card 630. Variable optics/focus may be especially desirable if capturing a real-time image of the customer's facial appearance 640.

FIG. 5B illustrates a video source 700 constructed in accordance with an alternative embodiment. The video source 700 may include a video camera having a camera housing 705 that carries a camera head 710 coupled to a camera control unit 720. Instead of a second camera head 660 such as that illustrated in FIG. 5A, the camera may include a pivoting mirror 730 that pivots between an out-of-the-way position 740 to capture a real-time image of the customer's facial appearance 640 and an angled position 750 to capture an image of the customer's identification card 630.

With reference to FIG. 1, in an alternative embodiment, instead of the camera capturing an image of both the customer's identification card 630 and facial appearance 640, the camera 250 may be adapted to only capture an image of the customer's identification card 630. In addition to capturing images of a customer's identification card 630, the camera 250 may also be used to capture images of other checkout activity such as images of items being checked out. For example, images of produce items being checked out may be captured by the camera 250 and displayed at the destination 650, e.g., at the attendant's station 320. The ability to capture images of produce items being checked out and display these images at the attendant station 320 allows the attendant 310 to remotely verify the identify and price of produce being checked out by the customer 330.

In a further embodiment, the video source 620 may be, at least in part, a magnetic strip reader such as the magnetic strip card reader 210 or an identification code reader (e.g., bar code scanner) such as the identification code reader 120. For example, if the video source 620 is a magnetic strip reader, an identification card such as a drivers license having a magnetic strip may be swiped through the magnetic strip reader. Information encoded on the magnetic stripe of the drivers license may include personal information and/or an image of the customer 330 or may be used to access stored personal information and/or an image of the customer 330 from memory, e.g., a central database.

With reference to FIG. 5C, in a similar fashion, if the video source 620 is an identification code reader 760 such a bar code scanner, an identification card 630 such as a drivers license having a bar code may be scanned using the reader 760. Information encoded in the bar code on the drivers license may be used to access stored personal information and/or an image of the customer 330 from memory, e.g., a central database, which is transmitted to the destination 650. Alternatively, the identification code reader 760 may be a scanner such as a CCD scanner adapted to capture an image of the front of the identification card 630. Customer information such as the customer's picture and personal information on the front of the identification card 630 may be captured by the CCD scanner by placing the identification card 630 face down on the a glass plate of the CCD scanner. A video camera 770 such as CCD camera may also be used to capture the customer's facial appearance 640 for identification verification.

Other reading devices may be used besides a magnetic strip reader and an identification code reader. For example, an automatic scanning device similar to the CCD scanner described above may be used with character recognition software so that specific fields and characters of a personal identification card may be read, interpreted, and automatically verified against other information, e.g., minimum age requirements for a purchase, to verify the customer's identity.

The video destination 650 is preferably the monitor 324 or the computer system 322 including the monitor 324 at the attendant station 320. In an alternative embodiment, the video destination 650 may be a computer and/or video monitor at another location in the retail establishment 305 or in a more remote location such as a central office for a number of retail establishments 305. The video destination 650 allows a viewer of the video destination 650 such as the attendant to remotely verify the identity of a customer 330 at the self-checkout system 100 for payment, age-verification, and/or security purposes.

A method of self-checkout of one or more items with a self-checkout system 100 and method of verifying one or more characteristics of a customer using a self-checkout system will now be described.

After selecting all desired shopping items at the retail establishment 305, the customer 330 brings all the items to one of the self-checkout systems 100. The display 140 preferably displays instructions that serve to guide the customer 330 through a checkout procedure. The display 140 is preferably a known touch-screen display that can generate data signals when certain areas of the screen are touched by the customer 330. The display 140 may instruct the customer 330 to begin by scanning multiple items. The customer 330 scans the identification code, e.g., bar code, of each item being purchased with the identification code reader 120.

In a preferred embodiment, the identification code reader 120 is a fixed bar code scanner and the bar code of each item is scan or read by placing the item over the reader 120, bar code side down. Although not shown, the scanner may include a light source such as a laser, a rotating mirror driven by a motor, and a mirror array. In operation, a laser beam reflects off the rotating mirror and mirror array to produce a pattern of scanning light beams. As the product identification code on an item is passed over the scanner, the scanning light beams scatter off the code and are returned to the scanner where they are collected and detected. The reflected light is then analyzed electronically in order to determine whether the reflected light contains a valid product identification code pattern. If a valid code pattern is present, identification information such as the SKU value along with price information for the item may be determined. The system 100 may acknowledge successful identification of a valid code pattern by an audible beep or other sign.

Examples of product identification codes that may be read include Universal Product Codes (UPC), i.e., bar codes, industrial symbols, alphanumeric characters, or other indicia associated with an item to be purchased.

A preferred fixed scanner for a high-volume location such as a grocery store checkout is a multi-scan window scanner such as the Magellan® scanner available from PSC Inc. of Eugene, Oreg.

In an alternative embodiment, the reader 120 is a hand-held scanner or other type of portable reader that may be moved to read the identification code of the item in a manner similar to that described above.

After or before identification and price information for an item is determined, a security verification process may be performed to verify that the items actually being checked out or removed from the store are the same items as those being read or scanned into the system 100. Otherwise, for example, a customer 330 may, for example, scan an inexpensive item or items, e.g., beans, multiple times while removing a more expensive item or items, e.g., steaks.

In a preferred embodiment, the security verification mechanism includes one or more of the scales 290 and the security verification process is a weighing process. However, in alternative embodiments an electronic scale and weighing process may be replaced or supplemented with other security verification mechanisms and procedures. For example, an image or images of an item from the surveillance camera 250 may be used by the attendant 310 to verify that the items being checked out or removed match those that are being scanned. The surveillance camera 250 or other image capturing device could be used to capture dimensional information for each item being checked out and this dimensional information could be compared to dimensional information associated with the SKU values for the items scanned for security verification purposes.

After scanning an item or multiple items, the item(s) is placed on the electronic scale 290. A weight for the item(s) is determined by the difference between the weight on the scale 290 before the item(s) was placed on the scale 290 and the weight on the scale 290 after the item(s) was placed on the scale 290. The weight is compared to weight information for the item(s) scanned to determine if the weight of the item on the scale 130, i.e., the item(s) actually being removed or checked out from the store match the weight information of the item(s) scanned. Preferably, as the weight of each item is verified, the system 100 will acknowledge security verification with an audible beep or other sign. After security verification, the price of the item may be retrieved from an appropriate database, a subtotal/total may be calculated, and identification of the item, the price of the item, and/or a subtotal/total may be displayed on the display 140, printed, and/or broadcasted via the speakers 150. If security verification is unsuccessful, the attendant 310 may be notified. The customer 330 may then be instructed to put the scanned item on the scale 130, which is preferably integrated with the reader 120, and the attendant 310 is requested to verify that the item on the scale 130 is truly what the customer 330 scanned. If the attendant 310 verifies that the item scanned is the item on the scale 130, this new weight may be accepted into a weight look-up database and the attendant 310 may ask the customer 330 to put the item on the security bagging scale 290. The attendant 310 may want to override the security scale violation instead of letting the customer 330 go through the re-weigh activity described above. The attendant can do that by touching an “override” portion of the display 140 so that the customer 330 does not have to remove and weigh the item. Data from the security bagging scale 290 is preferably not accepted as weight input into the weight look-up database.

The items being checked out may include a magnetic tag, RFID tag, electronic tag or other tag to prevent the items from being removed from the retail establishment 305 without properly checking the items out. If an item is properly scanned, the electronic article surveillance deactivator 230 may be actuated, causing a deactivating coil to be energized and the tag on the item to be deactivated or removed. If an item was not properly scanned, the tag remains on the item and is sensed by the electronic article surveillance monitor 300. The customer 330 may then be prompted to re-scan the item. If scanning is successful, the tag will be deactivated or removed.

After all the items have been scanned and weight verified, the customer 330 may present coupons for scanning by the coupon reader 190 or the scanner-scale 120. The customer 330 may then request the final bill by, for example, selecting an appropriate input on the touch screen display 140, making a voice request recognized by a voice recognition mechanism of the system 100, or performing some other bill requesting act with respect to an input device. In response to the customer's request, the total purchase price is displayed on the display 140, and the bill is printed out by the receipt printer 200. The customer tenders payment to the checkout system 100.

If the customer 330 is checking out an age-restricted item such as tobacco products, alcoholic beverages, or certain solvents, an ID check may be required. An ID check may also be required for security reasons or if a check, credit card, and/or cash card is being submitted for payment. The self-checkout computer 260 may determine that an age-restricted item has been read, and the customer 330 may be prompted via visual instructions on the display 140 or audible instructions via the speakers 150 that an identification check is required. This identification verification process may be required after each age-restricted item is scanned, after multiple age-restricted items are scanned, or after all items to be purchased have been scanned.

In one embodiment, the customer 330 presents an identification card 630 as proof of his or her identity in view of the video source 610 such as any of the cameras illustrated in FIGS. 1, 5A, and 5B. The video source 610 captures an image of the identification card 630, and the image is transmitted to the destination 650, where the image is viewed on the monitor 324 by the attendant 310. The self-checkout system 100 may simultaneously institute some form of an alarm, e.g., a flashing light, audible noise, etc. at the system 100 and/or at the attendant station 320, to notify the attendant that identification verification is required. The attendant 310 may then view the identification card 630 on the monitor 324 and view the customer 330, who is preferably within plain view of the attendant 310, and verify customer's 330 identification. The system 100 may or may not require a response from the attendant 310 to end the identification verification procedure. If a response is required, the attendant 310 may enter an appropriate response via the attendant computer system 322. For security purposes, the image of the identification card 630 may be recorded or otherwise stored along with information related to the particular self-checkout transaction.

In a similar fashion, a real-time image of the customer's appearance 640 may be captured by the video source 610 instead of or in addition to the customer's identification card 630 and a resulting image may be transmitted to and displayed at the destination 650. It may be desirable to capture and view a real-time image of the customer 330 at the self-checkout system 100 if the attendant or other person monitoring the customer is not within plain view of the customer 330. For example, additionally capturing and displaying a real-time image of the customer's appearance 640 allows the attendant 310 to be at a location other than where the attendant 310 has a plain view of the customer 330. For example, the attendant 310 may be at a location in the retail establishment 305 other than the general area of the self-checkout systems 100, or at a location entirely separate from the retail establishment 305 such as a central office for a chain of the retail establishments 305. From this remote location, the attendant 310 may view a real-time image of the customer 330 and the customer's identification card 630 from a monitor or other display device to verify the customer's identification.

As described above, if the video source 610 is a magnetic strip reader, the customer 330 may swipe a magnetic strip on his or her personal identification card, e.g., drivers license, through the magnetic strip reader. The magnetic strip may include an image of the customer and/or personal identification information encoded therein or the magnetic strip may include information encoded therein that is used to obtain an image of the customer 330 and/or personal information, e.g., age, of the customer 330 from memory, e.g., a central database. The stored image and/or personal information of the customer 330 is transmitted to the video destination 650 for customer identification verification by the attendant 310 as described above.

Further, if the video source 610 is an identification code reader such as a barcode scanner, the customer 330 may scan a barcode on his or her personal identification card with the identification code reader. The barcode may include information encoded therein that is used to obtain an image of the customer 330 and/or personal information, e.g., age, of the customer 330 from memory, e.g., a central database. The stored image and/or personal information of the customer 330 is transmitted to the video destination 650 for customer identification verification by the attendant 310 as described above.

Because an attendant 310 can remain at the attendant station 320 and verify the identity of customers 330 at the station 320, without having to constantly walk over to the self-checkout system 100, the video verification system reduces labor costs associated with self-checkout systems, increases the available time of employees that would normally perform such duties, and reduces the inconvenience to customers 330 caused by such intervention.

With reference to FIG. 6, a video identification verification system 800 constructed in accordance with another embodiment will be described. The video identification verification system 800 preferably includes or is part of a Local Area Network (LAN) residing at the retail establishment 305. However, in an alternative embodiment the video identification verification system 800 may include or be part of another type of network such as, but not by way of limitation, a Metropolitan Area Network (MAN), a Wide Area Network (WAN), and the internet.

The video verification system 800 includes multiple video sources 810 such as any of the video cameras discussed above located at respective self-checkout systems 100 for capturing an image of the customer's facial appearance 640 and/or obtaining an image of the customer's identification card 630 (or stored personal information of a customer and/or a stored image of the customer such as that found on a drivers license through, for example, a magnetic strip or barcode on the customer's drivers license in the manner described above). Although three video sources 810 are shown, the number of video sources may vary depending on the number of self-checkout systems in the retail establishment 305 and the type of activity to be captured.

The present inventors recognized that a video verification system having numerous video sources and destinations requires a system with large bandwidth capability, which usually translated into higher system cost, but system cost could be reduced with little or no sacrifice in bandwidth through the use of shared system hardware. The inventors determined that system hardware may be shared through multiplexing.

Thus, the video verification system 800 may include a multiplexer 820 coupled to the video sources 810 via communication lines 822 to combine the video and/or data streams from the multiple video sources 810 into one stream so that the multiple video sources 810 can share one communication line 825. The communication lines 822, 825 may be any well-known connection media such as, but not by way of limitation, twisted pair cabling, coaxial cable, fiber optics, or wireless media.

A digitizer 830 such as an analog-to-digital (A/D) converter is preferably used to convert an analog stream from the video sources 810 to a digital stream for later computer processing of the stream. It should be noted, in an alternative embodiment, if no computer processing of the stream is performed, the digitizer 830 may not be required. The digitizer 830 may be integral with the multiplexer 820 or separate therefrom.

A central computer 840 such as a central server may process the digital signals from the digitizer and transmit them to multiple destinations 850. The central computer 840 preferably resides at a hub in the LAN in, for example, a wiring closet of the retail establishment 305. Processing may include regeneration, filtering, formatting, conditioning, etc. of the signals. As indicated above, in an alternative embodiment, the central computer 840 may not exist if digital signals are not transmitted through the system 800.

A demultiplexer 860 that matches the multiplexer 820 may be used to separate the digital stream from the communication line 825 into multiple streams to be transmitted to the respective destinations 850 via communication lines 870. The communication lines 870 are preferably similar to communication lines 822, 825 described above.

The destinations 850 preferably reside at the respective attendant stations 320. The destinations 850 are preferably either a video monitor 324 or a computer system 322 having a video monitor 324. The destinations 850 allow respective attendants 310 to view an image of the customer's ID 630 (or personal information and/or a stored image of the customer such as that normally found on a drivers license) and/or real-time facial image 640 for identification verification purposes. The ratio of destinations 850 to video sources 810 may depend, for example, on the desired ratio of attendant stations 320 to self-checkout systems 100. For example, in a preferred embodiment, the ratio of video sources 810 to destinations 850 is four-to-one, i.e., identification images from four self-checkout systems 100 are transmitted to one attendant station 320 for verification viewing by the attendant 310. However, the ratio of video sources 810 to destinations 850 may vary, e.g., two-to-one, three-to-one, etc. There may also be multiple destinations for the video images, e.g., display in the “back-office” as well as at the attendant station 320.

The video verification system 800 will now be described in use. As discussed above, a customer 330 may be prompted by the self-checkout system 100 for proof of identity. Accordingly, an image of the customer's identification card 630 (or stored personal information of a customer and/or a stored image of the customer such as that found on a drivers license through, for example, a magnetic strip or barcode on the customer's drivers license in the manner described above) and/or facial appearance 640 may be captured by the video source 810, e.g., camera (See FIGS. 1, 5A, 5B), magnetic card reader, barcode scanner, and transmitted via the communication line 822 to the multiplexer 820 as a video and/or data stream. The multiplexer 820 combines the streams from the respective video sources 810 into one stream so that the multiple video sources 810 can share the one communication line 825. If the streams include analog signals, these signals may be converted to digital signals or a digital stream by the digitizer 830. The central computer 840 processes these digital signals, and the signals are separated and sent to respective destinations 850 by the demultiplexer 860. At the destination 850, the image of the customer's identification card 630 (or stored personal information of a customer and/or a stored image of the customer) and/or facial appearance 640 is displayed and viewed by the attendant 310 to verify the customer's identity.

The video verification system 800 allows for numerous video sources, e.g., cameras, magnetic card readers, barcode scanners, at numerous respective self-checkout systems and destinations, e.g., computers, monitors, at multiple attendant stations to verify a customer's identity with shared system hardware and, hence, at a reduced system cost.

Although the present invention has been described above in the context of certain preferred embodiments, it is to be understood that various modifications may be made to those embodiments, and various equivalents may be substituted, without departing from the spirit or scope of the invention.

What we claim is:

1. A method of verifying an identification of a customer using a self-checkout system of a retail establishment, comprising the steps of:
obtaining an image of a customer's identification at the self-checkout system;
displaying the customer's identification at a location remote from said self-checkout system to verify the identification of said customer.

2. The method of claim 1, wherein said customer's identification comprises a personal identification card, the step of obtaining comprises capturing an image of the personal identification card, and the step of displaying comprises displaying the image of the personal identification card at a location remote from said self-checkout system to verify the customer's identification.

3. The method of claim 2, wherein the step of displaying comprises displaying the customer's personal identification card at an attendant station to verify the customer's identification.

4. The method of claim 1, wherein the step of verifying the identification of the customer comprises verifying an age of the customer.

5. The method of claim 1, wherein the step of verifying the identification of the customer comprises verifying a name of said customer.

6. The method of claim 1, wherein the step of verifying the identification of the customer comprises verifying a facial appearance of said customer.

7. The method of claim 1, wherein said customer's identification comprises a facial appearance of said customer, the step of obtaining comprises capturing an image of the facial appearance of said customer, and the step of displaying comprises displaying an image of the facial appearance of said customer at a location remote from said self-checkout system to verify at least one of an age of said customer and an identity of said customer.

8. The method of claim 1, wherein said customer's identification comprises a personal identification card and a facial appearance of said customer, the step of obtaining comprises capturing an image of the personal identification card and an image of the facial appearance of said customer, and the step of displaying comprises displaying the image of the personal identification card and an image of the facial appearance of said customer at a location remote from said self-checkout system to verify the identification of said customer.

9. The method of claim 8, wherein the step of obtaining comprises capturing an image of the personal identification card with a video camera at the self-checkout system.

10. The method of claim 8, wherein the step of obtaining comprises capturing an image of the personal identification card with a product identification code reader at the self-checkout system.

11. The method of claim 1, further comprising storing said image.

12. The method of claim 1, wherein said customer's identification comprises a stored image of the customer and stored personal information of said customer, the step of obtaining comprises obtaining the stored image of the customer and the personal information of said customer by swiping a magnetic strip of an identification card through a magnetic card reader, and the step of displaying comprises displaying the stored image of the customer and the stored personal information at a location remote from said self-checkout system to verify the customer's identification.

13. The method of claim 1, wherein said customer's identification comprises a stored image of the customer and stored personal information of said customer, the step of obtaining comprises obtaining the stored image of the customer and the personal information of said customer by scanning a barcode on an identification card using a barcode scanner, and the step of displaying comprises displaying the stored image of the customer and the stored personal information at a location remote from said self-checkout system to verify the customer's identification.

14. A video identification verification system for a self-checkout system of a retail establishment, comprising:
a video source for use at the self-checkout system and adapted to obtain an image of a customer's identification; and
a video destination coupled to said video source and located at a location remote from said self-checkout system, said video destination adapted to display an image of said customer's identification to verify the identification of said customer.

15. The system of claim 14, wherein said video source is adapted to capture an image of a customer's personal identification card, and said video destination is adapted to display an image of said customer's identification card to verify at least one of an age of the customer, a name of said customer, and a facial appearance of said customer.

16. The system of claim 14, wherein said video source comprises a CCD camera.

17. The system of claim 14, wherein said video source is a product identification code reader.

18. The system of claim 14, wherein said video source is a magnetic strip reader.

19. The system of claim 14, wherein said video source is adapted to capture an image of a customer's facial appearance, and said video destination is adapted to display an image of said customer's facial appearance to verify at least one of an age of the customer and an identity of said customer.

20. A method of verifying the identification of multiple customers of multiple respective self-checkout systems of a retail establishment, comprising the steps of:
capturing images of the customers' respective identifications as respective video streams;
combining the multiple video streams into a single stream with a multiplexer;
separating the single stream into multiple video streams with a demultiplexer;
displaying multiple images of the customers' respective identifications resulting from said video streams at multiple destinations to verify the identifications of said customers.

21. The method of claim 20, wherein the step of capturing images comprises capturing images with video cameras and displaying images comprises displaying images with monitors.

22. The method of claim 20, wherein the step of capturing comprises capturing images of customers' identification cards to verify at least one of an age of the customer, a name of said customer, and a facial appearance of said customer.

23. The method of claim 20, wherein the step of capturing comprises capturing images of customers' facial appearances to verify at least one of an age of the customer and an identity of said customer.

24. The method of claim 20, further comprising digitizing the video streams from said video sources.

25. The method of claim 24, further comprising processing the digitized video streams.

26. A video identification verification system for multiple respective self-checkout systems of a retail establishment, comprising:
multiple video sources for use at the respective self-checkout systems, each video source being adapted to capture an image of a customer's identification at the self-checkout system and convert the image into a video stream;
a multiplexer coupled to the video sources and adapted to combine the video streams from the video sources into one stream;
a demultiplexer coupled to the multiplexer and adapted to separate said one stream into video streams;
multiple destinations located remotely from said self-checkout system, said multiple destinations coupled to said demultiplexer for receiving said video streams, each destination adapted to display an image of said customer's identification to verify the identification of said customer.

27. The system of claim 26, wherein said video source comprises a video camera adapted to capture an image of a customer's personal identification card, and said destination is a monitor adapted to display an image of said customer's identification card to verify at least one of an age of the customer, a name of said customer, and a facial appearance of said customer.

28. The system of claim 26, wherein said video source is adapted to capture an image of a customer's facial appearance, and said destination comprises a monitor adapted to display an image of said customer's facial appearance to verify at least one of an age of the customer and an identity of said customer.

29. The system of claim 26, further comprising a digitizer coupled to said multiplexer and adapted to convert an analog video stream from said video source to a digital video stream.

30. The system of claim 29, wherein said digitizer is integrated with said multiplexer.

31. The system of claim 29, further comprising a computer adapted to process said digital video stream from said digitizer.

32. The system of claim 26, wherein said destination comprises a computer.

33. The system of claim 26, wherein said destination comprises a monitor.

34. The system of claim 26, wherein said system is part of a network, said network being a member of the group consisting of a Local Area Network, a Metropolitan Area Network, a Wide Area Network, and the internet.
